(19) United States
(12) Patent Application Publication
(10) Pub. No.: US 2004/0073789 A1
(43) Pub. Date: Apr. 15, 2004

(54) Method for collaborative software licensing of electronically distributed computer programs

(76) Inventor: John Stephenson Powers, Fairfax, VA (US)

Correspondence Address: JOHN S. POWERS, 4415 SAN CARLOS DR., FAIRFAX, VA, 22030, US

(21) Appl. No.: 10/271,387

(22) Filed: Oct. 15, 2002

(51) Int. Cl. H04L 9/00

(52) U.S. Cl. 713/165; 713/193; 713/178; 713/201

(57) ABSTRACT

A method for controlling access to a computer program, and to derivative works based upon the program, with a single software key the contents of which may be determined by multiple independent parties to development of the final work.

### CROSS REFERENCE TO RELATED APPLICATIONS

None

### STATEMENT REGARDING FEDERALLY SPONSORED RESEARCH AND DEVELOPMENT

This invention was developed without assistance from any government agency.

### BACKGROUND OF THE INVENTION

1. Field of the Invention

This invention relates to the field of licensing computer software to prevent unauthorized use. More specifically, this invention enables multiple independent business entities to participate in the collaborative development and secure electronic distribution of a software product via a single license. This invention represents a fusion of ‘open source’ and ‘closed source’ models of software creation.

2. Description of Related Art

‘Open source’ software broadcasts the source code for a product, from which users may build a binary executable by compiling and linking the source code on a target machine. The attraction of open source is that once in a user's possession the source code may be modified, enabling collaborative development of new products, or improving the functionality of existing products. There is no means of controlling use of an executable built from ‘open source’ software.

‘Closed source’ software is developed and maintained by a single business entity that keeps the source code for a product a closely guarded trade secret. Collaborative development is impossible, since changes to source code are made only by the original vendor, and only binary executables are distributed. Binary executables are not modifiable by the user, and their use is commonly restricted by licensing technology which ‘unlocks’ the software only after a licensing fee has been paid for receipt of a ‘key’.

Both development models suffer disadvantages which impact software markets and users. ‘Open source’ software requires that individuals and organizations invest time and capital in development efforts where control of sensitive intellectual property will be lost when the source code is distributed. Revenue is generated by selling the source code with a legal agreement restricting use and redistribution, or marketing convenience of access and technical support to freely available source code and executables. Both business models are very weak. The business model where software developers are obliged to work without compensation and surrender independently developed intellectual property as a condition for participating in collaborative development is a glaring weakness of the ‘Open Source’ model.

‘Closed source’ software cannot be modified by anyone other than the vendor. Specialized niche markets may not be served in favor of more profitable mass markets. Revenues from the sale of software are concentrated in a relatively few business entities that wield ever increasing control over software markets, to the extent that markets become monopolized. As software markets come under increasingly centralized control, prices increase and innovation declines as developers and potential investors see no chance for profitability in competing with established vendors. A few generic products dominate what would otherwise be a much more diverse marketplace supporting more highly specialized applications.

The invention of ‘Collaborative Development Licensing Technology’ (CDLT) described herein makes it mutually profitable for multiple, independent entities to collaboratively develop software to serve specialized markets. Such software is based upon a closed-source ‘kernel program’ that is designed to serve as a standalone product, as well as a development platform for more specialized derivative works based upon the product. Said closed source ‘kernel program’ is protected by robust licensing described herein, and this licensing is easily extended to protect closed source derivative works based upon the kernel program. Developers may improve a kernel program, market the derivative work independently, and profit by serving as a broker for kernel licenses which will also enable the derivative work, said licenses sold at a markup over the cost of kernel program licenses.

All parties to a CDLT project profit by independently developing and improving a product, yet no party is required to release sensitive intellectual property in the form of source code. CDLT provides the advantages of collaborative development offered by ‘open source’ software, while providing the solid business model, revenue stream, and intellectual property protection of ‘closed source’ software. CDLT enables collaborative development using ‘closed source’.

Using CDLT, business entities with sufficient resources will have a powerful incentive to create kernel software programs which may be extended by derivative works, because they will receive a license fee to the kernel program for every derivative work sold, and derivative works (improved versions of the kernel program) are created at zero cost to the vendor of the kernel program. Similarly, each distributor of a derivative work represents a zero cost point of marketing and distribution for the kernel product vendor. The vendor can facilitate the creation of derivative works without surrendering any valuable intellectual property. The kernel program vendor profits from selling licenses to the standalone product, as well as kernel licenses to derivative works of the product sold in markets not addressed by the original product.

CDLT gives independent developers a powerful incentive to create derivative works of kernel programs, because they may profit from creating and distributing such works. This is because access to improved or specialized functionality in derivative works may be restricted to those who purchase licenses through the derivative work developer. Developers are not required to broadcast source code, and retain all rights to intellectual property they create; including the right to patent it or keep it secret. Developers with specialized domain knowledge may thus rapidly field products into niche markets by leveraging the massive development effort represented by a stable kernel program to build upon.

Under the business model made possible by this invention, kernel programs provide free access to a link library and applications programming interface (API) to any interested party. The provision of a link library also fulfills the legal requirements for commercial products which utilize binary ‘open source’ based libraries distributed under the ‘GNU Library General Public License’ (LGPL) of the Free Software Foundation. This enables the use of ‘Open Source’ based libraries in commercial products run on ‘Open Source’ operating systems.

CDLT is not to be confused with the marketing of ‘libraries’ or software ‘components’ which may be integrated with commercial products in return for royalty payments based upon number of units sold. Instead, CDLT uses the model of paying a markup over the cost of a ‘base’ product for ‘customizing’ the product. Derivative work developers purchase a ‘base’ license to a kernel product from the original vendor. Only the derivative work developer has sufficient information to specify a license which will enable the derivative work. The developer may then resell the license at a markup supported by the customized features of the derivative work not offered by the kernel product. The markup is whatever the market will bear for the work.

All current software licensing schemes share the common characteristics that the key for unlocking access to a program must be purchased from the original vendor of the program by the end user, and the key will only unlock a single instantiation of a program. The notion that a key can be sold indirectly, that a key can be specified by multiple parties, and that a single key may control access to multiple instantiations of an application with variable functionality created by multiple business entities serving multiple markets, simply does not exist in any form in the related art prior to this invention. This invention makes possible a business model for software development which does not exist in any form at this time.

### SUMMARY OF THE INVENTION

Collaborative Development Licensing Technology (CDLT) is a methodology and software implementation for controlling access to programs, and derivative works of programs, by use of an encrypted key which may be defined by multiple business entities operating independently. There is no requirement for communication or agreement between participating business entities beyond common adherence to legalities defined in a CDLT licensing agreement distributed with the kernel application. Terms of licensing are largely confined to safeguarding intellectual property of all developers, preventing fraud, and preventing the distribution of malicious derivative works. The CDLT licensing agreement is an implementation detail, but not a component of, this application.

Under CDLT licensing, anyone with a license to the kernel program is entitled to create a derivative work based upon the kernel program; is entitled to free access to the link library and API defined by the kernel program; and is free to market and distribute a derivative work (or works) based upon the kernel program, royalty free. Developers of derivative works are under no obligation to protect their improvements using CDLT. Developers may ‘open source’ their improvements and freely distribute their derivative work, thus making their enhancements to the kernel program freely available to anyone in possession of a kernel program license. The open-source distribution of derivative work enhancements does not compromise the intellectual property of the original kernel application; in either case a kernel license is required.

### BRIEF DESCRIPTION OF THE DRAWINGS

FIG. 1 is a block diagram depicting the transaction flow among participating parties in the CDLT process. Note that an end user may receive licensing directly from the kernel program vendor, or indirectly via a derivative work developer serving as a broker for licenses from the kernel program vendor. By serving as a license broker, the derivative work developer is able to insert a derivative work ‘access code’ into the license application, which will result in a license that will enable the derivative work. The developer may also sell such licenses at a markup over the kernel license.

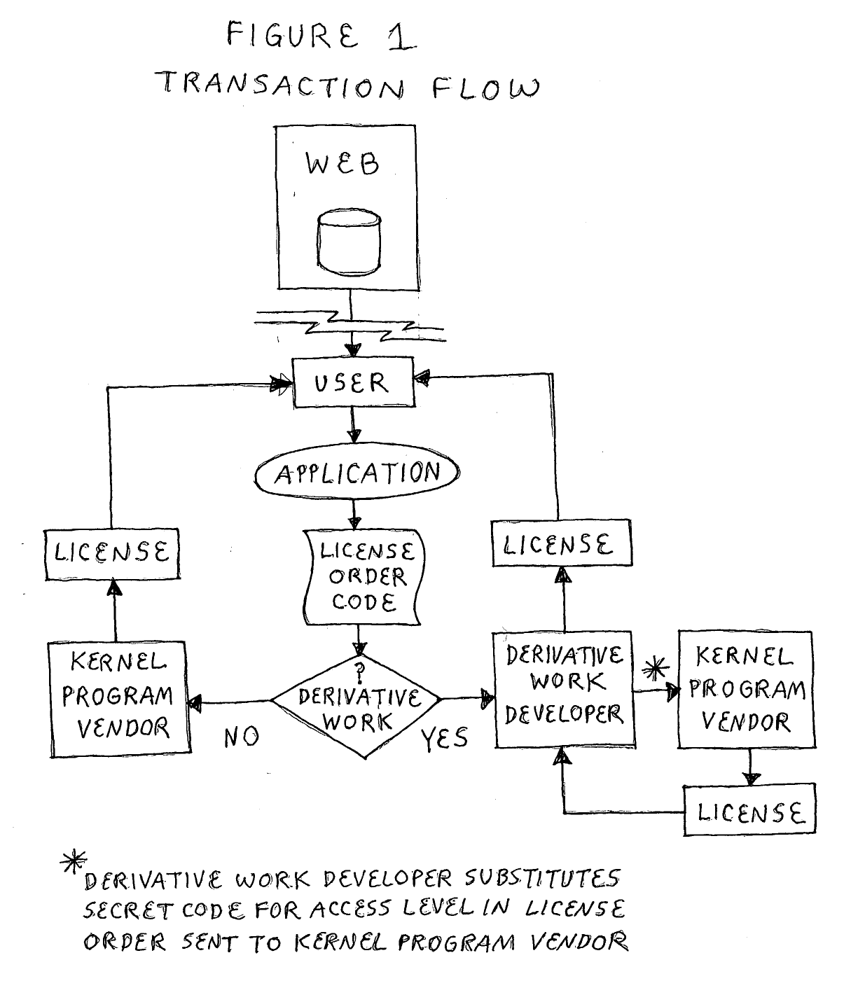

FIG. 2 is a block diagram depicting the method of creating a ‘temporary license’, and a ‘license order code’ specifying a ‘extended license’ which will enable a program on a target machine. Temporary license creation occurs automatically the first time an application is activated. A license order code is created on demand by the application user.

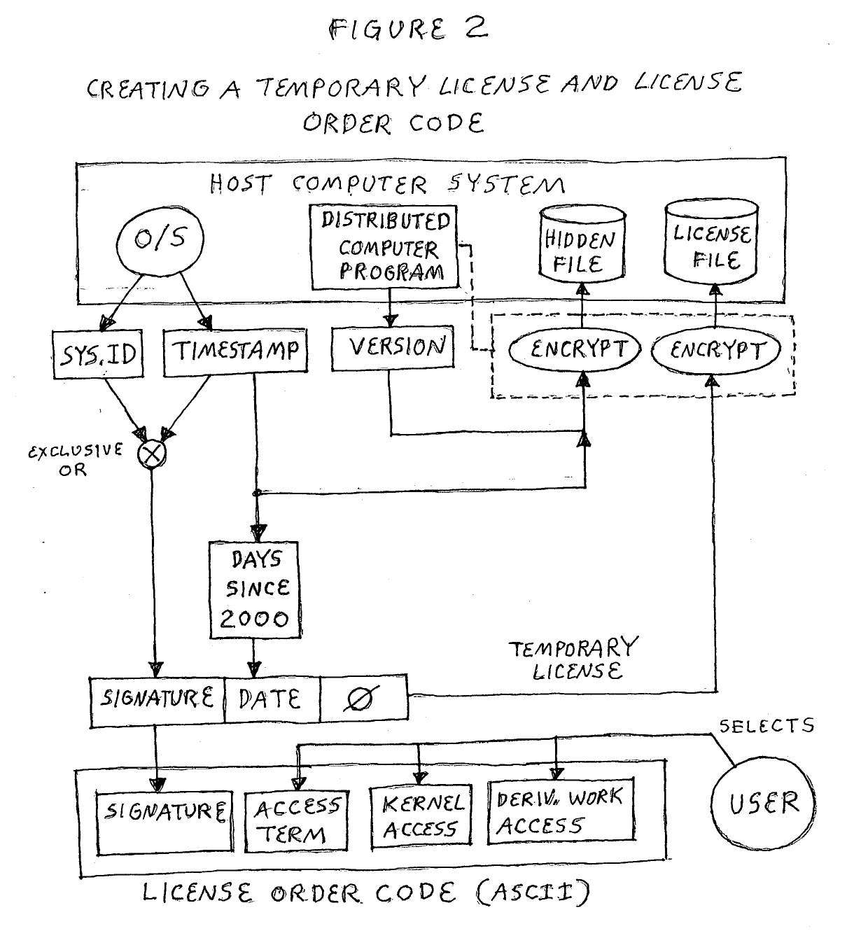

FIG. 3 is a block diagram depicting the method of creating an encrypted ‘extended license’ from a ‘license order code’ created by the distributed application on a target machine.

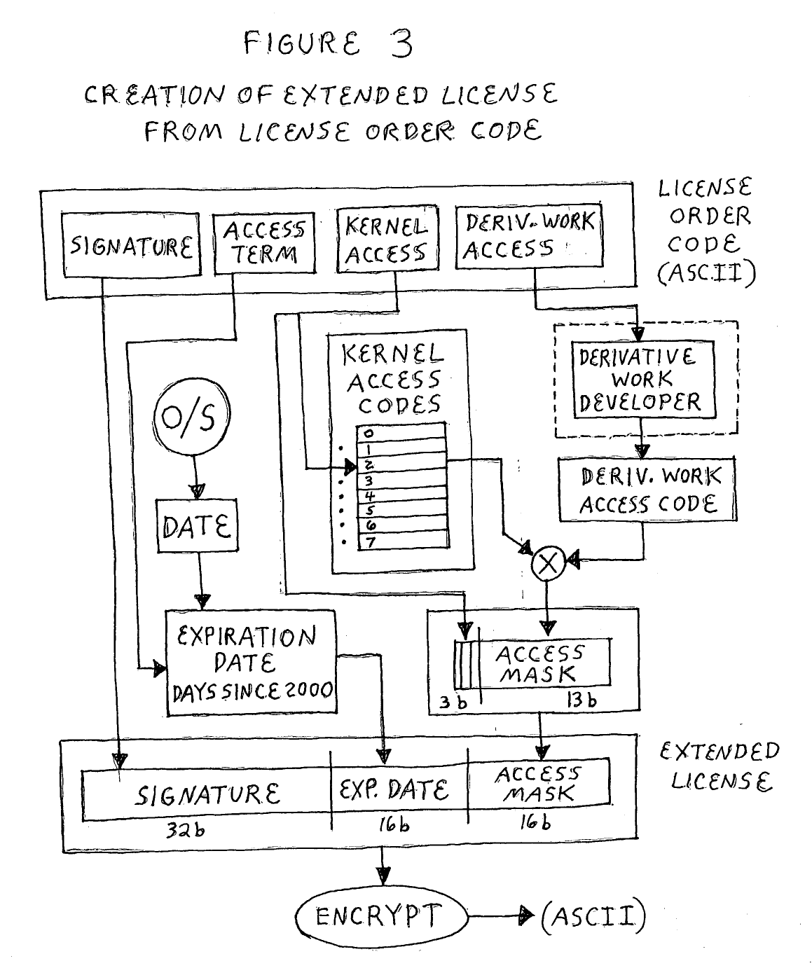

FIG. 4 is a block diagram depicting how licensing information is decrypted and extracted from an ‘extended’ or ‘temporary’ license by an application. Once this information is extracted, computing the validity and access level of a license is straightforward.

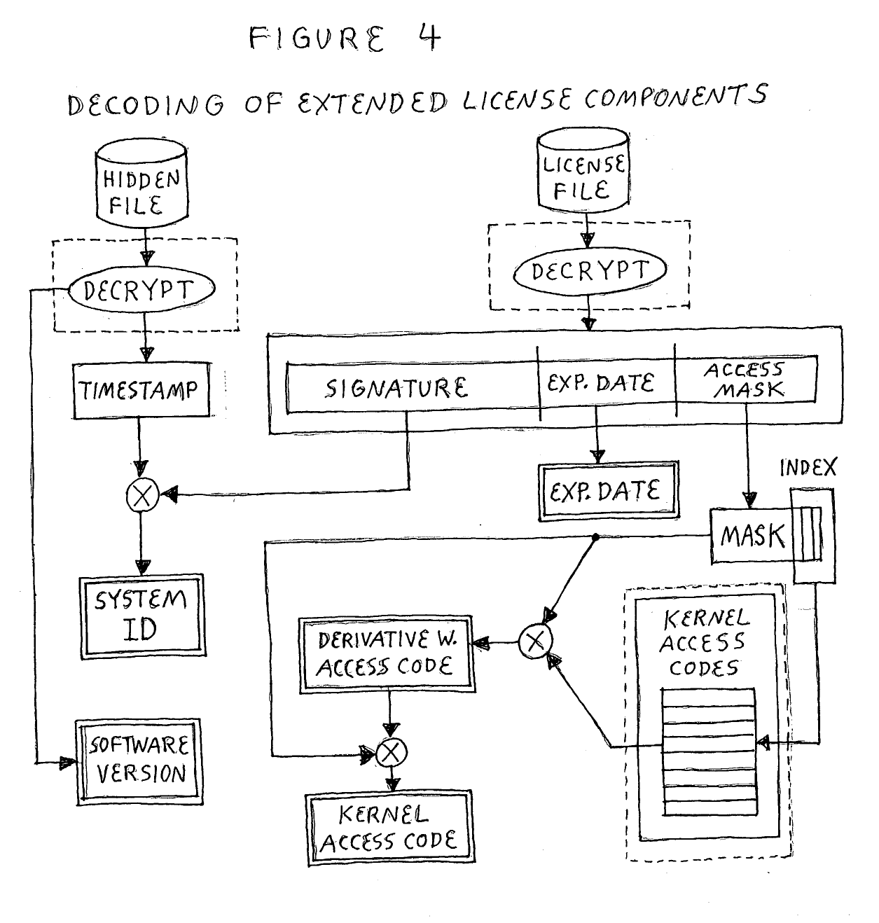

### DETAILED DESCRIPTION OF THE INVENTION

The Collaborative Development Licensing Technology (CDLT) invention described herein, consists of a computer software component. The software component is linked with a distributed program, and is accessible to derivative works of the program, via an API. When linked with a program, CDLT restricts access to the program, and derivative works of the program, to a single computer with an installed CDLT key unique to that computer. The same software component also enables a distributed program to generate a temporary license when installed, and generate a ‘License Order Code’, which is communicated to the licensing entity (with payment) for an extended duration software key which may enable higher levels of functionality. The ‘License Order Code’ specifies a unique system identifier, an access level for the program, and an optional access code specifying the access level for a derivative work based upon the program. The term of license may also be specified, or left as a default. CDLT is designed to be simple to implement, compact, and utilize a small (64 bit) key.

The ‘Licensing Program’ at the vendor site which creates CDLT software keys for distributed copies of a program uses the identical CDLT component that is linked with the distributed programs. The only difference is a ‘compiler flag’ in the CDLT component which determines if the component is being compiled into a distributed application, or into the ‘Licensing Program’. The ‘Licensing Program’ converts a ‘License Order Code’ created by each distributed program into an extended duration software key which will enable that program on the target machine that created the ‘License Order Code’. Each ‘License Order Code’ is unique. A single licensing program creates keys for all copies of a distributed program linked using a CDLT software component.

The central concept in the above is existence of a single CDLT software component which serves the dual purpose of enforcing licensing in a distributed application, and generating keys which permit access to the application, depending on which flags are set when it is compiled.

The sub-components of CDLT consist of an encryption/decryption module, a ‘kernel product configuration module’ which defines encryption keys and access codes to a kernel product, a ‘derivative work configuration module’ which defines access codes to a derivative work, and the CDLT logic module. Different sections of the CDLT logic module are implemented when compiled, depending upon whether the logic module is being linked with the distributed program, or the undistributed ‘Licensing Program’ which converts ‘license order codes’ into license keys enabling the software.

The encryption module is symmetric, secret key encryption. The encryption key used to encrypt the software key by the licensing program at the vendor site is the same encryption key used to decrypt the software key by the distributed program. The specific implementation of secret key encryption is not claimed as part of this invention. The encryption keys are maintained internally by the ‘kernel product configuration module’ of the CDLT software component. Different applications, or different versions of an application, are differentiated by changing the internal encryption keys. Encryption keys are never communicated externally in any form, but are integral to the CDLT software component. Multiple encryption keys may be supported by the CDLT software component in order to support multiple product versions. Note that derivative work developers cannot access or change any kernel application encryption key.

CDLT supports eight license access levels to the kernel application, and eight access levels to the derivative work. Access levels are numbered 0 to 7. Each access level enables all access levels beneath it. This permits marketing multiple levels of capability with a single software product. Access level zero is the ‘temporary or ‘free trial’ license level for both kernel and derivative work applications. Access level zero generally provides reduced functionality relative to higher levels.

Each access level for both the kernel application and derivative work is associated with an ‘access code’ defined by the developer. A software key will define an access code for the kernel application, and an access code for the derivative work. The access code in the software key must match an access code defined within the application for access to be granted for that access level. An access code of zero is reserved for access level zero (temporary licensing) for both kernel and derivative works.

CDLT also supports the appending of unencrypted, textual ‘tags’ to the license. Such tags enable the user to turn off unwanted functionality, or otherwise configure functionality permitted by the installed license by querying the presence of specified tags,

An installed CDLT application utilizes one of two possible software keys: a ‘temporary key’ providing a short period of free access to constrained functionality, or an ‘extended key’, providing an extended (but not unlimited) period of access to full functionality. A ‘temporary key’ is created automatically upon first activation of the application. An ‘extended key’ must be purchased, and is created from a ‘License Order Code’ created by the CDLT component in response to user input specifying:

1. the kernel license access level desired,

2. (optional) the derivative work license access level desired,

3. (optional) the term of access desired.

The only difference between a temporary key and the extended key is the period of access, and the access code.

When an application is activated, CDLT looks in a predetermined location on the local file system for an encrypted software key which will enable the application. If a key exists, the application reads and decrypts it. If a key does not exist, CDLT will create a temporary key, encrypt it, and install it at the predetermined location on the client machine. A temporary key defines a short term of ‘free trial’ use; usually 30 days. Free trial use is confined to ‘access level zero’ which generally excludes certain levels of functionality. Subsequent activations of the application will read and decrypt the temporary key. Users are prevented from simply recreating the temporary key when it expires by use of a hidden ‘timestamp’ file,

When creating the temporary key, CDLT also creates a hidden ‘timestamp’ file containing the system time (in seconds) when the temporary key was created, and the version of the application being licensed. This ‘timestamp’ is coupled (XORed) with the system identifier returned by the operating system to create a unique system signature. A license for one system will not enable a different system, even if the system name is identical, since the timestamp file will be different. If the timestamp file exists in the absence of a key, a temporary license will not be created if the software version is the same as that in the hidden file. Similarly, if a license exists without the hidden timestamp file, the license cannot be successfully decrypted. Such a scheme is not immune to piracy, but piracy requires non-trivial system knowledge, a detailed (as opposed to casual) methodology, and is confined to piracy of temporary (reduced) access, or access to computers possessing the same system identifier. The advantage of the scheme is its extreme simplicity.

An ‘extended key’ purchased from the application vendor differs from the ‘temporary key’ only in the term and level of access granted. Like the temporary key, the hidden timestamp file is required for successful decryption of the extended key. Except for the small hidden timestamp file and textual key file on disk, all other licensing components are internal to the licensed application. There is no external licensing ‘daemon’ process.

A product ‘license file’ may contain multiple software keys. Since the unique system signature includes the display node identifier, CDLT is amenable to regulating use of networked terminals by scanning a list of keys on a server, rather than a single key on each client. This prevents a single license key on a high performance server from serving an entire network.

Once the key has been read and decrypted, it must pass four tests to enable execution of the distributed kernel program. First, the system signature of the license must match the signature computed from information returned by the operating system and merged with the timestamp. Second, the computed creation date of the license may not be after the current system date. Third, the current date must precede the expiration date of the license. Fourth, the kernel program is queried for its access codes via an API call. The kernel access code on the license must match an access code in the list of up to 8 codes ingested from the kernel program by the CDLT component. The offset in the internal list of codes is the license access level. If any test fails, execution of the kernel program is politely declined and the application terminates.

If the license passes these tests, the derivative work licensing level is determined. The derivative work is queried for its access codes via an API call. The derivative work access code on the license must match an access code in the list of up to 8 codes ingested from the derivative work by the CDLT component. The offset in the internal list of codes is the derivative work license access level. If a match is found, the derivative work licensing level is the offset of the matching code in the list. If no code match is found, license access level negative one (−1) is assigned to the derivative work, indicating an invalid license access code for the derivative work. Invalid derivative work access codes have no effect on kernel program execution, however derivative work functionality may be blocked.

By serving as a license broker for the kernel application, a derivative work developer may control access to his work by substituting, on the license application, the internal secret access code corresponding to the desired access level requested by a user. If this secret access code is not substituted for the requested access level, the derivative work will remain inaccessible. Those desiring access to the derivative work functionality must purchase their licenses to the work through the derivative work developer, who knows the access code. A trial and error approach to pirating the secret access code is impractical, because a license must be purchased from the kernel vendor for each access code trial, there are thousands of possible codes, and the codes are easily changed by the derivative work developer.

The kernel application controls access during execution by calling the CDLT API which returns the kernel license access level. If the license access level is greater than or equal to the access level assigned to a function in the kernel work, the function is enabled. If not, execution of that function is declined, but the application does not terminate. The derivative work application uses an identical mechanism which is decoupled from the mechanism used by the kernel application. Licensing of derivative works via CDLT is voluntary. If the derivative work does not explicitly query the licensing level, and explicitly control execution flow based on the licensing level, all functionality of the derivative work is accessible via the kernel license. CDLT merely provides a means of communicating the licensing level to the derivative work logic so the derivative work may enforce access internally.

What is claimed is:

1. A method comprising:
a ‘CDLT software component’ linked with a distributed program for which licensing enforcement via access control is desired;
automatic installation on each client by said ‘CDLT software component’ of an encrypted hidden timestamp and ‘temporary license’ containing ‘access information’ which enables enforcement of a temporary access period, and access level, to the functionality of a program and derivative works based upon the program;
utilization by said ‘CDLT software component’ of said ‘access information’, with user input, to generate a unique ‘license order code’ specifying an extended access period and higher access level for a program and, optionally, specifying a desired access level for a derivative work based upon the program;
conveyance of said ‘license order code’ to a licensing authority directly by the customer, or indirectly via a derivative work developer acting as a license broker who substitutes a secret code internal to the derivative work in place of the requested derivative work access level;
utilization of said ‘license order code’ by said ‘CDLT software component’ linked into the vendor's licensing software to create an ‘extended license’ to the distributed program and, optionally, a derivative work based upon the program, which is unique to the computer which generated the order code and will not unlock the program on any other computer;
conveyance of said ‘extended license’ directly to the party which submitted the ‘license order code’ and provided payment for the ‘extended license’ or, if said party is a license broker, said broker conveys license to the end user of the program;
installation of said ‘encrypted extended license’ on the same computer which generated said ‘license order code’.
automatic decryption of said ‘extended license’ by said ‘CDLT software component’ and enforcement of the access period and access level specified for the kernel program and, optionally, enforcement of the access level specified for a derivative work based on the program.

2. The method of claim 1 wherein a single, identically configured ‘CDLT software component’ serves as the ‘licensing enforcement component’ for each copy of the distributed program, as well as the ‘vendor licensing program’ which creates licenses for said program. The mode depends on flags set at the time of compilation of the ‘CDLT software component’.

3. The method of claim 1 wherein each product category or version shall have a uniquely configured ‘CDLT software component’ with a different internal encryption key, and different internal access codes.
